(19) United States
(12) Patent Application Publication
(10) Pub. No.: US 2008/0099153 A1
(43) Pub. Date: May 1, 2008

(54) Display Panel Sealing Clip

(76) Inventors: Akihiro Fujimoto, Miyazaki (JP); Yasuhiro Matsuoka, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/722,804

(22) PCT Filed: Sep. 30, 2005
(86) PCT No.: PCT/JP05/18155

§ 371 Date: Jun. 26, 2007

(51) Int. Cl. B29C 65/48

(52) U.S. Cl. 156/580

(57) ABSTRACT

An attitude-changeable surface pressing member is attached to a front end of a clip such that substrates can evenly be pressed even if a distance clipped at the front end by the clip is changed during a heating process in a sealing process. A display panel sealing clip includes a pressing member which has a pair of clipping portions for clipping both the substrates and the tubulation tubing to apply pressure in a direction in which the pair of clipping portions is brought close to each other and a surface pressing member which presses the tubulation tubing by a surface thereof. The surface pressing member has a notch portion which surrounds a cylindrical portion of the tubulation tubing from three directions, and the surface pressing member is attached to one of the clipping portions of the pressing member in an attitude-changeable manner such that the flange portion is pressed by the surface of the surface pressing member even if a distance between the pair of clipping portions of the pressing member is changed after the tubulation tubing is tentatively fixed.

### TECHNICAL FIELD

The present invention relates to a display panel sealing clip, particularly to a display panel sealing clip which tentatively fixes a front-side substrate and a rear-side substrate along with a tubulation tubing in sealing the front-side substrate and the rear-side substrate when a display panel such as PDP (Plasma Display Panel) is produced.

### BACKGROUND ART

Conventionally, for example, in the display panel such as PDP, the front-side substrate and the rear-side substrate are arranged opposite to each other, and a discharge space is formed inside by sealing the surroundings of the front-side substrate and the rear-side substrate.

In producing such display panels, normally a vent hole which communicates the inside of the panel with the outside is provided in the rear-side substrate, and a glass tubulation tubing (also referred to as vent tubing or tip tubing) is bonded so as to cover the vent hole therewith during a sealing process in which the front-side substrate and the rear-side substrate are heated and sealed. An impurity gas is evacuated from the inside of the panel through the tubulation tubing, and the inside of the panel is filled with a discharge gas. Then, the tubulation tubing is fused such that an airway of the tubulation tubing is closed, which seals the discharge space.

In the sealing process, a sealing material is arranged between the front-side substrate and the rear-side substrate, a bonding material for the tubulation tubing is arranged near the tubulation tubing, the front-side substrate and the rear-side substrate are tentatively fixed by clipping the front-side substrate and the rear-side substrate along with the tubulation tubing using the display panel sealing clip, the front-side substrate and the rear-side substrate are placed into a heating furnace, and the tubulation tubing is bonded while the front-side substrate and the rear-side substrate are heated to seal both the substrates by a predetermined heating process.

Usually a clip, in which a plate-like spring material (for example, inconel) is folded in a substantial triangle and a notch is provided such that the tubulation tubing enters an opening, is used as the display panel sealing clip used in the sealing process (see Patent Document 1).

Patent Document 1: Japanese Unexamined Patent Publication No. 2001-307635

### DISCLOSURE OF THE INVENTION

### Problems to be Solved by the Invention

However, in the case of the use of the display panel sealing clip described in Patent Document 1, a front end of the display panel sealing clip comes into line contact with a flange portion provided in the tubulation tubing. Therefore, during the heating process in the sealing process, when a distance clipped with the display panel sealing clip is changed by softening the sealing material between both the substrates or by softening the bonding material of the tubulation tubing, even pressing force is not obtained through the heating process, which sometimes results in the inclined tubulation tubing or displaced tubulation tubing.

In such cases, when the front end of the display panel sealing clip is brought into contact with the pipe portion of the tubulation tubing by the displacement between the display panel sealing clip and the tubulation tubing, a flaw is generated in the tubulation tubing, which causes a problem that the tubulation tubing is folded down from the flaw. These obstruct sealing reliability near the tubulation tubing to lead to decreases in display quality and production stability of the display panel.

In view of the foregoing, an object of the present invention is to attach an attitude-changeable surface pressing member to the front end of the display panel sealing clip such that the substrates can evenly be pressed even if the distance clipped by the front end of the display panel sealing clip is changed during the heating process in the sealing process.

### Means for Solving the Problems

The present invention provides a display panel sealing clip which tentatively fixes a pair of substrates by clipping the substrates while tentatively fixing a tubulation tubing to the substrate when surroundings of the substrates are sealed, the substrate having a vent hole which communicates an inside of a panel with an outside, a sealing material being arranged in the surroundings of the substrates, the substrates being arranged opposite to each other, the tubulation tubing including a cylindrical portion and a flange portion formed at one end of the cylindrical portion being arranged such that the flange portion faces the vent hole, said display panel sealing clip comprising: a pressing member which has a pair of clipping portions for clipping both the substrates and the tubulation tubing, the pressing member applying pressure in a direction in which the pair of clipping portions is brought close to each other; and a surface pressing member which presses the tubulation tubing by a surface of the surface pressing member, wherein the surface pressing member has a notch portion which surrounds a cylindrical portion of the tubulation tubing from three directions, and the surface pressing member is attached to one of the clipping portions of the pressing member in an attitude-changeable manner such that the flange portion is pressed by the surface of the surface pressing member even if a distance between the pair of clipping portions of the pressing member is changed after the tubulation tubing is tentatively fixed.

### Effects of the Invention

In accordance with the present invention, even if the distance clipped with the clipping portions is changed by softening the sealing material during the heating process in the sealing process, the flange portion of the tubulation tubing is pressed by the surface of the surface pressing member attached to the clipping portion. Therefore, the tubulation tubing can always evenly be pressed, and the generation of the flaw is prevented in the tubulation tubing while the inclination and displacement of the tubulation tubing are prevented. Accordingly, the sealing reliability near the tubulation tubing can be improved, a defect generated near the tubulation tubing can be prevented, and the display panel having the good display quality can be obtained.

### BRIEF DESCRIPTION OF THE DRAWINGS

FIG. 1 is an explanatory view showing a first embodiment of a display panel sealing clip of the present invention.

FIG. 2 is an explanatory view showing a configuration of a surface pressing member of the first embodiment.

FIG. 3 is an explanatory view showing a state in which a tubulation tubing is tentatively fixed by a display panel sealing clip.

FIG. 4 is an explanatory view showing a second embodiment of the display panel sealing clip of the present invention.

FIG. 5 is an explanatory view showing a state before sealing the substrates with the display panel sealing clip.

FIG. 6 is an explanatory view showing a state during and after sealing substrates with the display panel sealing clip.

### Explanations of Letters or Numeral

1 display panel sealing clip

2 and 12 spring pressing member

2a upper-side retaining portion

2b lower-side retaining portion

3 surface pressing member

3a notch portion

3b displacement preventing recess portion

4 screw

5 clipping portion

11 front-side substrate

12a and 12b clipping piece

14 opening operation portion

15 coupling rotary portion

21 rear-side substrate

31 tubulation tubing

31a cylindrical portion of tubulation tubing

31b flange portion of tubulation tubing

32 bonding member

33 bonding assist member

34 sealing material

35 vent hole

### BEST MODE FOR CARRYING OUT THE INVENTION

A display panel sealing clip according to the present invention is used when the display panel sealing clip tentatively fixes both substrates by clipping the substrates while tentatively fixing a tubulation tubing to the substrate in sealing the surroundings of the substrates. The substrate has a vent hole which communicates the inside of the panel with the outside, the sealing material is arranged in the surroundings of the substrates, the substrates are arranged opposite to each other, the tubulation tubing including a cylindrical portion and a flange portion formed at one end of the cylindrical portion is arranged such that the flange portion faces the vent hole. Accordingly, the display panel sealing clip of the present invention can be applied to any panel as long as the display panel sealing clip is used in the above application.

In the present invention, a pressing member has a pair of clipping portions which clips both the substrates and the tubulation tubing, and any pressing member may be applied as long as the pressing member can pressurize the pair of clipping portions in a direction in which the clipping portions are brought close to each other.

For example, a clip which is formed by folding a plate-like spring material made of inconel in a substantial triangle can be applied to the pressing member. Alternatively, the pressing member may be formed by a pair of clipping pieces having a pair of clipping portions for clipping both the substrates and the tubulation tubing at a front end, an opening operation portion at a rear end, and a coupling rotary portion at a substantially intermediate portion of the pair of clipping pieces. Specifically, for example, a scissors-shape clip formed by a pair of clipping pieces made of a SUS plate material and a coil-shape spring material made of inconel may be applied to the pressing member.

Any surface pressing member may be applied as long as the surface pressing member can press the tubulation tubing by the surface thereof. The surface pressing member has a notch portion which surrounds a cylindrical portion of the tubulation tubing from three directions, and the surface pressing member is attached to one of the clipping portions of the pressing member in an attitude-changeable manner such that the flange portion is pressed by the surface of the surface pressing member even if a distance between the pair of clipping portions of the pressing member is changed after the tubulation tubing is tentatively fixed. Desirably the surface pressing member is attached to one of the clipping portions of the pressing member in a point or substantially line contact manner. Desirably the surface pressing member has a recess portion which prevents displacement with the tubulation tubing.

The present invention will be described in detail below with reference to embodiments shown in the drawings. The present invention is not limited to the embodiments, but various modifications can be made.

### First Embodiment

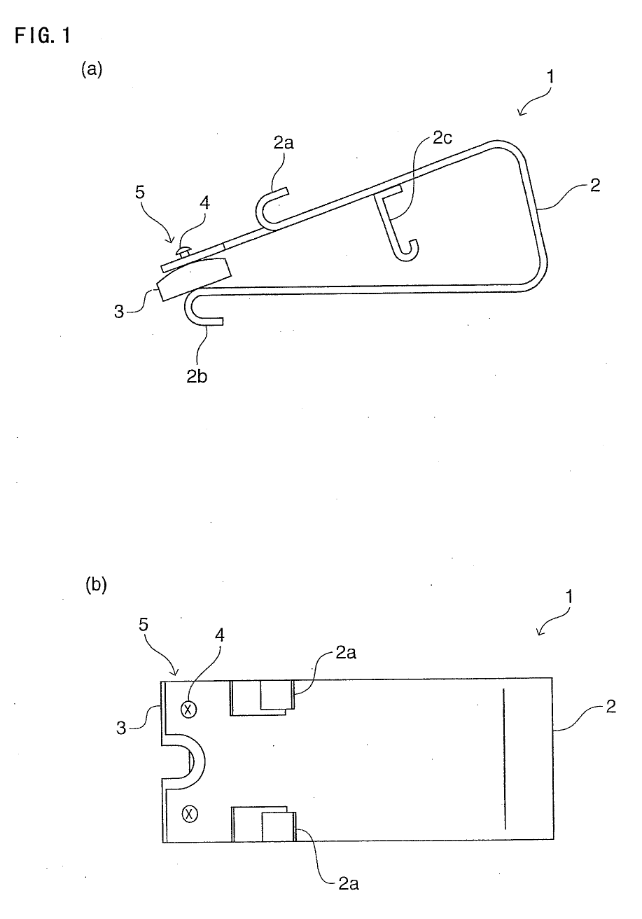

FIG. 1(a) and FIG. 1(b) are explanatory views showing a first embodiment of a display panel sealing clip of the present invention. FIG. 1(a) is a front view of the display panel sealing clip and FIG. 1(b) is a plan view. The display panel sealing clip of the present invention is used to tentatively fix the tubulation tubing in sealing the rear-side substrate and front-side substrate for PDP.

A display panel sealing clip 1 of the first embodiment includes two constituents, i.e., a spring pressing member 2 which pressurizes the tubulation tubing with a spring and a surface pressing member 3 which presses the tubulation tubing by the surface thereof. The spring pressing member 2 is folded in U-shape, and the pair of clipping portions is formed on both end portions of the spring pressing member 2. The spring pressing member 2 and the surface pressing member 3 are coupled by a screw 4 so as to be able to change an attitude of the surface pressing member 3, and the surface pressing member 3 is formed so as to be always brought into even contact with the tubulation tubing in the surface of the surface pressing member 3. The surface pressing member 3 includes a recess portion for preventing displacement with the tubulation tubing which prevents displacement between the display panel sealing clip 1 and the tubulation tubing.

A clip which is formed by folding the plate-like spring material made of inconel in the substantial triangle is used as the spring pressing member 2. A front end of the spring pressing member 2 constitutes a clipping portion 5 which clips the tubulation tubing.

A plate-like member made of, e.g., a SUS material is used as the surface pressing member 3. In the surface pressing member 3, the opposite side to the side which is in contact with the tubulation tubing, i.e., the side which is coupled to the spring pressing member 2 is molded in a triangle or an arc shape. The displacement preventing recess portion is provided on the side which is in contact with the tubulation tubing, and the recess portion is formed in a concave shape so as to be matched with the flange shape of the tubulation tubing. The alignment is performed between the display panel sealing clip 1 and the tubulation tubing by fitting the tubulation tubing in to the displacement preventing recess portion.

An upper-side retaining portion 2a and a lower-side retaining portion 2b are formed in the spring pressing member 2, the upper-side retaining portion 2a and the lower-side retaining portion 2b are hooked by an opening assist tool to open the clipping portion 5, and the rear-side substrate and the front-side substrate are clipped along with the tubulation tubing and tentatively fixed by the clipping portion 5.

An oscillation preventing member 2c is provided in the spring pressing member 2. The oscillation preventing member 2c is one which comes into contact with the rear-side substrate to restrain the oscillation of the spring pressing member 2 in the state in which both the substrates are clipped with the clipping portion 5.

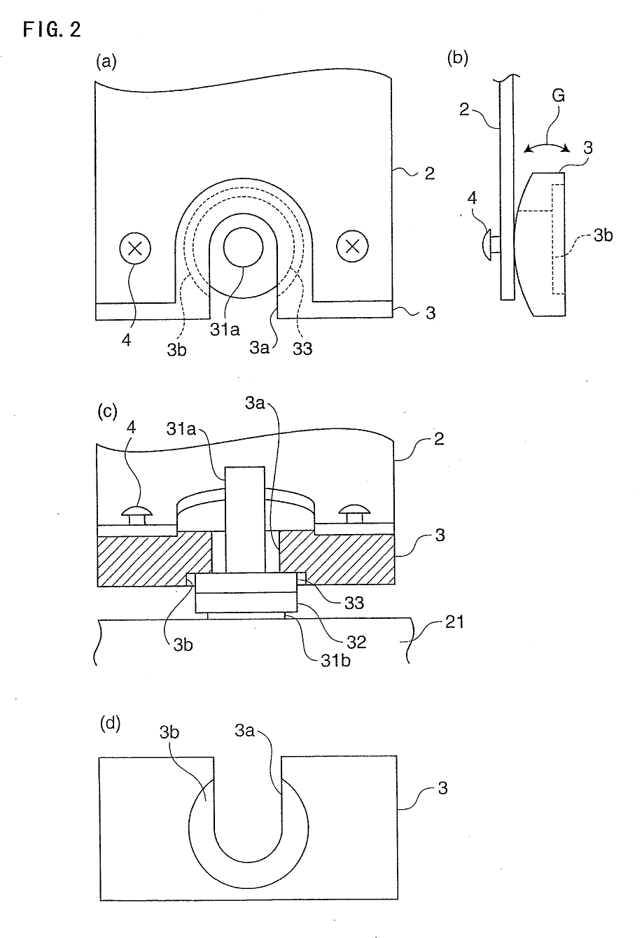

FIGS. 2(a) to 2(d) are explanatory views showing a configuration of the surface pressing member. FIG. 2(a) is a plan view of the surface pressing member, FIG. 2(b) is a side view of the surface pressing member, FIG. 2(c) is a front view of the surface pressing member, and FIG. 2(d) is a rear-side view of the surface pressing member.

The surface pressing member 3 is one which presses a tubulation tubing 31 by the surface of the surface pressing member 3. The tubulation tubing 31 includes a cylindrical portion 3 la and a flange portion 31b, and the flange portion 31b abuts on a rear-side substrate 21. A ring-shape bonding member 32 and a bonding assist member 33 are arranged in an outer circumference of the flange portion 31b.

The surface pressing member 3 has a notch portion 3a which surrounds the cylindrical portion 31a of the tubulation tubing 31 from three directions. After the tubulation tubing 31 is tentatively fixed, the surface pressing member 3 is attached to the spring pressing member 2 in the attitude-changeable manner such that the flange portion 31b is pressed by the surface of the surface pressing member 3 even if the distance between the pair of clipping portions 5 is changed.

Specifically, as shown in FIG. 2(b), an attachment surface of the surface pressing member 3 is formed in the arc shape, the arc-shape surface is in line contact with the spring pressing member 2, and the surface pressing member 3 is attached with a screw 4 so as to wobble at the line-contact position. Accordingly, in the surface pressing member 3, the attitude can be changed in a direction shown by G in FIG. 2(b). The attachment surface of the surface pressing member 3 is formed in the arc shape. However, the attachment surface may be in line contact or point contact with the spring pressing member 2, and the attachment surface may be formed in a triangular shape.

As shown in FIG. 2(d), a displacement preventing recess portion 3b is provided in the backside of the surface pressing member 3. The displacement preventing recess portion 3b prevents the displacement of the display panel sealing clip to the tubulation tubing 31. The displacement preventing recess portion 3b is formed in a size in which the ring-shape bonding member 32 and bonding assist member 33 which are attached to the outer circumference of the flange portion 31b of the tubulation tubing 31 are just fitted in the displacement preventing recess portion 3b.

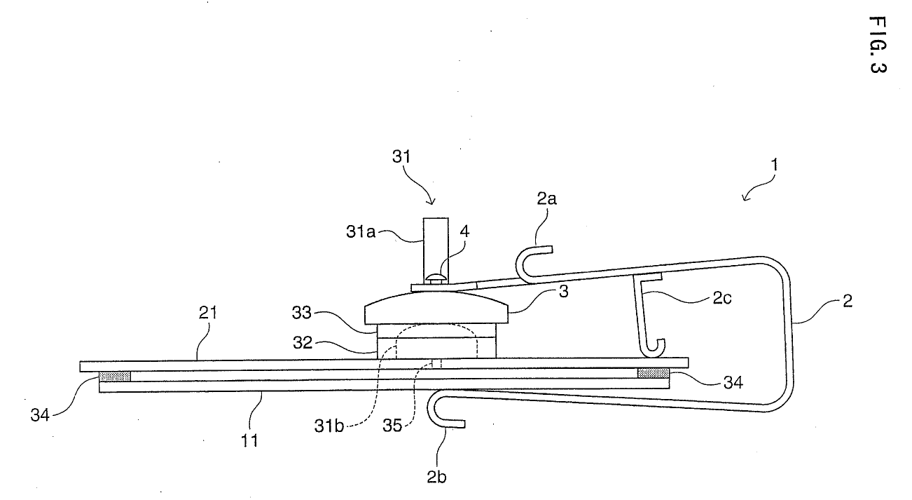

FIG. 3 is an explanatory view showing the state in which the tubulation tubing is tentatively fixed by the display panel sealing clip. The display panel sealing clip 1 tentatively fixes the tubulation tubing 31, when the tubulation tubing 31 is bonded to the rear-side substrate 21 while the rear-side substrate 21 and a front-side substrate 11 which face each other are sealed in the state in which a sealing material 34 is arranged in the surroundings. A vent hole 35 is made in the rear-side substrate 21 to communicate the inside of the panel with the outside. The tubulation tubing 31 includes the cylindrical portion 31 a and the flange portion 31b formed at one end of the cylindrical portion 31a.

The display panel sealing clip 1 tentatively fixes the tubulation tubing 31 to the substrate 21 while clipping the substrates 11 and 21 to tentatively fix the substrates 11 and 21 when the flange portion 31b of the tubulation tubing 31 faces the vent hole 35 to seal the surroundings of the substrate while the inside of the panel is evacuated through the tubulation tubing 31. In the tentative fixing, the display panel sealing clip 1 is opened with the opening assist tool, and the display panel sealing clip 1 tentatively fixes the tubulation tubing by clipping the tubulation tubing.

When the inside of the panel is evacuated, the inside of the panel becomes a negative pressure, and thereby a suction force acts between the front-side substrate 11 and the rear-side substrate 21. Because the sealing material 34 is softened by heating while pressurized by both the substrates, a clipping amount of the pair of clipping portions of the spring pressing member 2 is changed. However, at this point, the surface pressing member 3 is coupled to the spring pressing member 2 in the attitude-changeable manner, so that the flange surface of the tubulation tubing 31 can always evenly be pressed to prevent the inclination or crack of the tubulation tubing 31. The bonding member 32 of the tubulation tubing 31 is also softened when the sealing material 34 is softened, which changes the clipping amount of the pair of clipping portions of spring pressing member 2.

### Second Embodiment

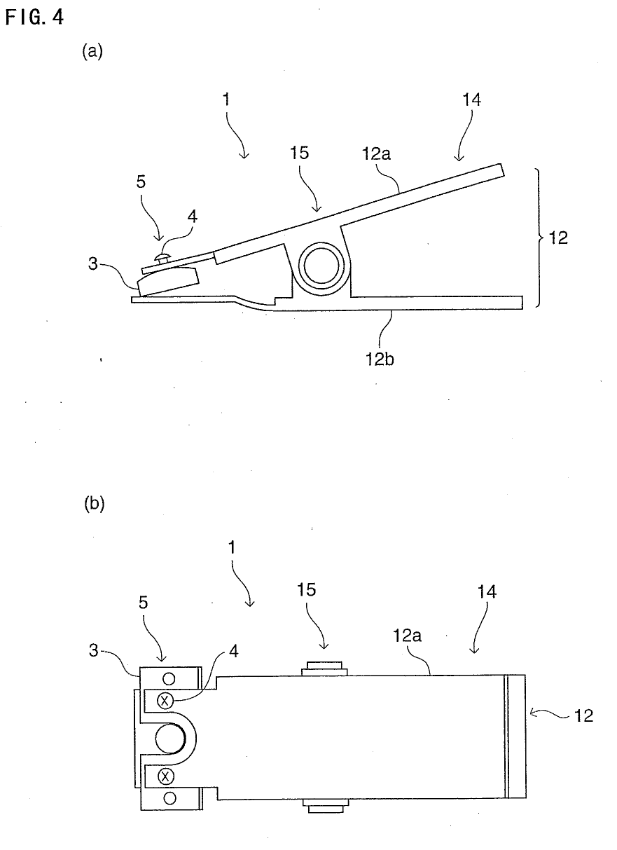

FIG. 4(a) and FIG. 4(b) are explanatory views showing a second embodiment of a display panel sealing clip of the present invention. FIG. 4(a) is a front view of the display panel sealing clip and FIG. 4(b) is a plan view. The display panel sealing clip 1 of the second embodiment has a scissors shape in an outline, and the display panel sealing clip 1 includes two constituents, i.e., a spring pressing member 12 which pressurizes the tubulation tubing with a spring and the surface pressing member 3 which presses the tubulation tubing by the surface thereof. The spring pressing member 12 and the surface pressing member 3 are coupled by the screw 4 so as to be able to change an attitude of the surface pressing member 3, and the surface pressing member 3 is formed so as to be always brought into even contact with the tubulation tubing in the surface of the surface pressing member 3. The surface pressing member 3 includes the recess portion which prevents the displacement between the display panel sealing clip 1 and the tubulation tubing.

In the spring pressing member 12, the scissors-shape clip is formed by a pair of clipping pieces 12a and 12b made of a SUS plate material and a coil-shape spring material (not shown) made of inconel. The pair of clipping pieces 12a and 12b is formed to face each other.

In the pair of clipping pieces 12a and 12b, the front end constitutes the clipping portion 5 which clips the tubulation tubing, the rear end constitutes an opening operation portion 14, and the substantially intermediate portion constitutes a coupling rotary portion 15. The pair of clipping pieces 12a and 12b is rotatably coupled by the coupling rotary portion 15, and the pair of clipping pieces 12a and 12b is biased toward a direction in which the clipping portion 5 of the pair of clipping pieces 12a and 12b abuts on the substrate by a spring (not shown) provided in the coupling rotary portion 15.

In the clipping piece 12a, the surface pressing member 3 is attached to the clipping portion 5 to press the flange portion of the tubulation tubing by the surface of the surface pressing member 3. The surface pressing member 3 has the same configuration as the first embodiment. In the second embodiment, unlike the first embodiment, the tubulation tubing can be clipped and tentatively fixed with no opening assist tool by forming the display panel sealing clip 1 in the scissors shape.

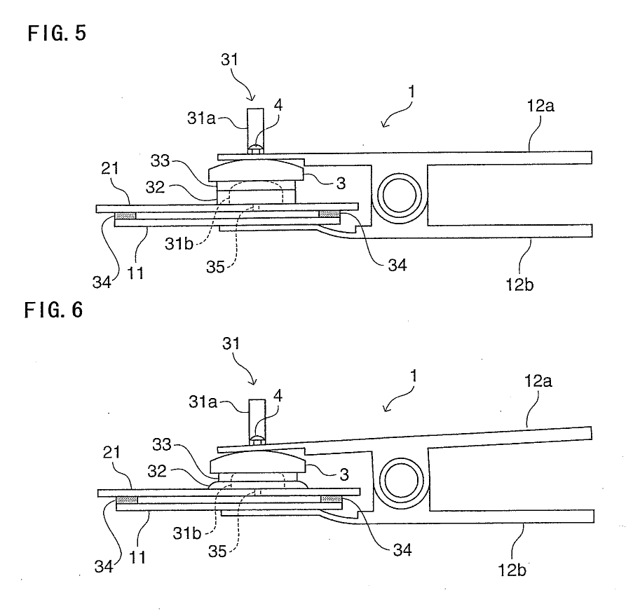

FIG. 5 and FIG. 6 are explanatory views showing the sealing state of the display panel sealing clip. FIG. 5 shows the state before sealing the substrates, and FIG. 6 shows the state during and after sealing the substrates. These drawings illustrate an example in which the display panel sealing clip of the second embodiment is used.

Before sealing the substrates, as shown in FIG. 5, the sealing material 34 and the bonding member 32 are not softened. In this state, the tubulation tubing 31 is clipped along with the substrates 11 and 21 by the display panel sealing clip 1, and the tubulation tubing 31 is tentatively fixed by the surface pressing member 3.

During and after sealing the substrates, as shown in FIG. 6, the sealing material 34 and the bonding member 32 are softened by heating. In this case, in the clipping portion, the pair of clipping pieces 12a and 12b is biased toward the direction the clipping pieces 12a and 12b are brought close to each other by the spring. However, because the surface pressing member 3 abuts on the flange portion 31b of the tubulation tubing 31, the clipping pieces 12a and 12b are not brought close to each other any more. At this point, a clipping angle of the display panel sealing clip is changed from the state in which the substrates are not sealed. However, because the attitude of the surface pressing member 3 is changed, the flange portion 31b of the tubulation tubing 31 can always be pressed by the plane.

Thus, when the rear-side substrate 21 and the front-side substrate 11 are sealed while the tubulation tubing is tentatively fixed, the surface pressing member 3 is coupled to the clipping piece 12a in the attitude-changeable manner even if the clipping amount of the pair of clipping pieces 12a and 12b is changed. Therefore, the flange surface of the tubulation tubing 31 can always evenly be pressed to prevent the inclination or crack of the tubulation tubing 31.

In the above embodiments, both the substrates are pressurized by the negative pressure generated in evacuating the inside of the panel. Alternatively, the surroundings of the substrates may be pressurized by plural clips. The display panel sealing clip can also be used only in the process of bonding the tubulation tubing.

1. A display panel sealing clip which tentatively fixes a pair of substrates by clipping the substrates while tentatively fixing a tubulation tubing to the substrate when surroundings of the substrates are sealed, the substrate having a vent hole which communicates an inside of a panel with an outside, a sealing material being arranged in the surroundings of the substrates, the substrates being arranged opposite to each other, the tubulation tubing including a cylindrical portion and a flange portion formed at one end of the cylindrical portion being arranged such that the flange portion faces the vent hole, said display panel sealing clip comprising:
a pressing member which has a pair of clipping portions for clipping both the substrates and the tubulation tubing, the pressing member applying pressure in a direction in which the pair of clipping portions is brought close to each other; and
a surface pressing member which presses the tubulation tubing by a surface of the surface pressing member,
wherein the surface pressing member has a notch portion which surrounds a cylindrical portion of the tubulation tubing from three directions, and the surface pressing member is attached to one of the clipping portions of the pressing member in an attitude-changeable manner such that the flange portion is pressed by the surface of the surface pressing member even if a distance between the pair of clipping portions of the pressing member is changed after the tubulation tubing is tentatively fixed.

2. The display panel sealing clip according to claim 1, wherein the pressing member is formed by a pair of clipping pieces having a pair of clipping portions for clipping both the substrates and the tubulation tubing at a front end, an opening operation portion at a rear end, a coupling rotary portion at a substantially intermediate portion of the pair of clipping pieces.

3. The display panel sealing clip according to claim 1, wherein the surface pressing member is attached to one of the clipping portions of the pressing member in a point or line contact manner.

4. The display panel sealing clip according to claim 1, wherein the surface pressing member has a recess portion which prevents displacement with the tubulation tubing.

5. A clip which is used in bonding a flange-equipped tubulation tubing to a substrate of a plasma display panel using a bonding member, the flange-equipped tubulation tubing being used to evacuate said plasma display panel or to fill said plasma display panel with a discharge gas, the clip comprising:
a pair of clipping portions for clipping both the substrates and the flange portion of the tubulation tubing; and
a surface pressing member provided on one of the pair of clipping portions, which presses the flange portion of the tubulation tubing by a surface of the surface pressing member,
wherein said surface pressing member has a notch portion which surrounds a main body of the tubulation tubing from three directions, and said surface pressing member is formed in an arc shape such that an attitude of the surface which comes into contact with said clipping portion can be changed.
